(19) United States
(12) Patent Application Publication
(10) Pub. No.: US 2019/0095589 A1
(43) Pub. Date: Mar. 28, 2019

(54) SYSTEM AND METHOD FOR SELECTING, MODELING AND ANALYZING MITRAL VALVE SURGICAL TECHNIQUES

(71) Applicant: Board of Regents of the University of Texas System, Austin, TX (US)

(72) Inventors: Hyunggun Kim, Houston, TX (US); Sarah C. Vigmostad, Iowa City, IA (US); David D. McPherson, Houston, TX (US); Ahnryul Choi, Houston, TX (US); Yonghoon Rim, Houston, TX (US)

(21) Appl. No.: 14/318,344

(22) Filed: Jun. 27, 2014

Related U.S. Application Data
(60) Provisional application No. 61/840,992, filed on Jun. 28, 2013.

(51) Int. Cl. G06F 19/00

(52) U.S. Cl. CPC G06F 19/3437

(57) ABSTRACT

Embodiments disclosed herein provide a system and method for selecting, modeling and analyzing various surgical treatments of mitral valves. In some embodiments, a mitral valve is simulated based on imaging and Doppler ultrasound data acquired from the mitral valve. The function of the mitral valve is simulated, and then a plurality of surgical techniques is simulated for the mitral valve to help determine the best mitral valve treatment.

### CROSS-REFERENCE TO RELATED APPLICATION(S)

This application is a conversion of and claims a benefit of priority from U.S. Provisional Application No. 61/840,992, filed Jun. 28, 2013, entitled “SYSTEM AND METHOD FOR SELECTING, MODELING AND ANALYZING MITRAL VALVE SURGICAL TECHNIQUES,” which is fully incorporated by reference herein for all purposes.

### STATEMENT REGARDING FEDERALLY SPONSORED RESEARCH OR DEVELOPMENT

This invention was made with Government support under HL109597 awarded by the National Institutes of Health. The Government has certain rights in the invention.

### TECHNICAL FIELD

This disclosure relates generally to the field of surgical procedures. More specifically, the disclosure relates to the computerized modeling of a patient's organ and subsequent selection of a technique appropriate for repair of the organ. Even more particularly, the disclosure relates to systems and methods for virtual surgical simulation and evaluation of mitral valve (MV) repair using computational simulation and analysis techniques combined with clinical imaging modalities such as three-dimensional (3D) echocardiography and standard clinical guidelines for diagnosis and treatment of MV pathology.

### BACKGROUND

The mitral valve is a dual leaflet valve in the heart that lies between the left atrium (LA) and the left ventricle (LV). It has two cusps, or leaflets, that enclose the valve opening. The opening is surrounded by a fibrous ring known as the mitral valve annulus. The anterior cusp protects approximately two-thirds of the valve. These valve leaflets are prevented from prolapsing into the left atrium by the action of tendons and papillary muscles attached to the left ventricular wall, which are referred to as chordae tendineae.

When the left ventricle contracts, the intraventricular pressure causes the mitral valve to close, while the tendons keep the leaflets coapting together and prevent the valve from opening in the wrong direction to prevent backflow of blood into the left atrium (regurgitation). During diastole, a normally-functioning mitral valve opens as a result of increased pressure from the left atrium as it fills with blood (preloading). As atrial pressure increases above that of the left ventricle, the mitral valve opens. Opening facilitates the passive flow of blood into the left ventricle. Diastole ends with atrial contraction, which ejects the final 20% of blood that is transferred from the left atrium to the left ventricle. The mitral valve closes at the end of atrial contraction to prevent a reversal of blood flow.

During left ventricular diastole, after the pressure drops in the left ventricle due to relaxation of the ventricular myocardium, the mitral valve opens, and blood travels from the left atrium to the left ventricle. Left atrial contraction causes added blood to flow across the mitral valve immediately before left ventricular systole.

Pathological alterations of one or more components will cause abnormal MV function, accounting for approximately 100,000 surgeries per year. There are different types of problems typically associated with the mitral valve. The first type is related to aging and may be referred to generally as a degenerative condition, while the second typically is present at birth and may be referred to as congenital. Congenital problems may result from morphological alterations, or the like.

Frequently, problems with the mitral valve may be identified during an EKG. If there is a problem, echocardiography (ultrasound imaging)—which is able to produce images of the heart with the most clarity—may be used to further diagnose the medical condition. Once the mitral valve has been identified as the problem, a decision must be made whether to repair or replace the mitral valve. Currently, about 90% of cases use surgical repair to treat mitral valve deficiencies.

Surgical treatments for MV repair have been present for many years. Initially, MV repair was limited to a small percentage of MV cases, but it is now employed by surgeons in more than 90% of cases. In the early days of MV repair, a repair involving plication (folding) of the commissures between the anterior and posterior leaflets was popular for cases with centrally-directed insufficiency jets. More involved treatments were developed utilizing placement of an annuloplasty ring to decrease annular diameter and improve coaptation of the anterior and posterior leaflets. These techniques increased the rate of repair by more than 50% in patients undergoing surgery for MV insufficiency. Recent advances including replacement of the chordae tendineae and chordal shortening with annuloplasty rings have resulted in a repair rate of more than 90%.

When a decision is made to perform surgery on the MV, the dimensions of the MV are measured to determine the morphology of the MV, the flow patterns are studied, and then a procedure is selected. Information such as patient data (including history), test data (e.g., injecting a dye into the patient to see particular blood flow), etc., are personally analyzed by clinicians (e.g., echocardiologists and cardiac surgeons) to understand the morphology of the heart and to aid in selecting a procedure. Once a technique is selected, surgery is performed on the heart, the heart is filled with saline and compressed, and the heart is checked for leakage. If there is no leakage, the surgery is generally considered to be a success. If there is leakage, the surgeon tries a different technique. Thus, the possibility of success depends upon the skill and experience of the surgeon.

An unsolved problem in MV repair surgery is predicting which repair is optimal for each patient. Much of the difficulty lies in not precisely understanding MV physiology which predisposes it to dysfunction and insufficiency. Moreover, the majority of cases have complex pathophysiologic involvement combining multiple pathologies including MV annular enlargement, chordal lengthening, chordal rupture, calcification of the MV structures, lack of leaflet coaptation, etc. Conventional imaging techniques cannot accurately determine which pathology is present and which repair will produce the least stress and tension on the leaflets. If imaging techniques can be combined with appropriate computational MV evaluation methods, then improved diagnosis and therapeutic approaches to MV repair can be developed.

### SUMMARY OF THE DISCLOSURE

Embodiments disclosed herein provide a system and method for simulating and evaluating MV surgical techniques. In some embodiments, MV data is acquired from a patent, including imaging data and ultrasound data. The acquired MV data is used to create a virtual MV model. The function of the virtual MV model is simulated, and MV valve repairs are simulated using a plurality of surgical techniques. A user can use the results and evaluations of the simulations to select one or more the most optimal surgical techniques for repairing the MV.

Using embodiments as described herein, patient data may be acquired and used to model a patient MV, the function of the MV may be simulated and analyzed to identify one or more surgical treatments, each possible treatment may be simulated, analyzed and evaluated, and surgical decision recommendations may be determined and presented accordingly.

Embodiments as disclosed herein may provide relevant information that may assist healthcare providers by providing medical recommendations.

Embodiments disclosed herein allow patient-specific biomechanical and functional evaluation of MV pathology and help echocardiologists and cardiac surgeons to improve diagnoses and pre-surgical planning of MV repair intervention.

Embodiments of systems and methods for MV repair simulation and evaluation may consider most primary types of surgical techniques for MV repair in current clinical settings. Embodiments may include direct clinical applications by employing computational simulations with patient-specific MV image data to provide objective interventional strategies for MV repair.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The drawings accompanying and forming part of this specification are included to depict certain aspects of the invention. A clearer impression of the invention, and of the components and operation of systems provided with the invention, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts a flow chart illustrating steps that may be used to implement one embodiment of a method for identifying, selecting, simulating, or analyzing surgical treatments;

FIG. 2 depicts a flow diagram illustrating one embodiment of a method for virtual MV repair simulation and evaluation; and

FIG. 3 depicts one embodiment of a system for implementing methods for simulating virtual MV repair.

FIGS. 4-5 show a series of protocol schematics of the computational MV modeling.

FIG. 6 is a sample screenshot showing the computational simulation of MV repair.

FIG. 7 shows images and models of a normal MV.

FIG. 8 shows images and models of a pathologic MV.

FIGS. 9-10 show various views of a pathologic MV, pre-repair and post repair.

FIG. 11 is a bar graph illustrating the posterior leaflet bulging (mm) pre-repair and post-repair.

### DETAILED DESCRIPTION

The invention and the various features and advantageous details thereof are explained more fully with reference to the nonlimiting embodiments that are illustrated in the accompanying drawings and detailed in the following description. Descriptions of well-known starting materials, processing techniques, components and equipment are omitted so as not to unnecessarily obscure the invention in detail. It should be understood, however, that the detailed description and the specific examples, while indicating preferred embodiments of the invention, are given by way of illustration only and not by way of limitation. Various substitutions, modifications, additions and/or rearrangements within the spirit and/or scope of the underlying inventive concept will become apparent to those skilled in the art from this disclosure.

Embodiments disclosed herein may be particularly useful for selecting, modeling and analyzing various surgical treatments. In particular, the physiologic characteristics of the MV may be assessed for accurate diagnosis and appropriate treatment of MV pathology, such as mitral regurgitation and mitral prolapse.

The most common treatment for early MV pathology is surgical repair, with valve replacement performed if the MV is severely diseased. A thorough understanding of the MV dynamics and functional characteristics of the MV apparatus is imperative for accurate diagnosis and focused treatment to MV pathology. Computational evaluation of MV function may provide valuable structural and fluid dynamic information that cannot be obtained from currently available imaging data alone. Embodiments disclosed herein may be useful for simulating and recommending one or more of a number of types of interventional treatments such as, but not limited to, annuloplasty, leaflet resection, chordal replacement, clipping, plication and chordae/papillary muscle transposition (or combinations thereof) to repair pathological MVs.

Virtual simulation and evaluation of MV repair provide a powerful tool to provide comprehensive and quantitative patient-specific biomechanical and functional information before and after MV repair. Advantageously, embodiments may be useful for providing a recommended course of action, may allow visualizing how the surgery should happen, and may provide some idea of how the heart will function after a surgery has been performed. Embodiments may still provide additional information that can be useful, such as for identifying alternative treatments.

Embodiments of a virtual MV repair simulation and evaluation may be composed of multiple sub-algorithms including patient MV image data acquisition, 3D virtual MV modeling, computational simulation of MV function, surgical planning for MV repair, virtual MV repair simulation, and evaluation of the virtual MV repair simulation. Some or all of the processes described below can be performed in an automated fashion. It is not required that a user have complete knowledge of details of what the system is doing at each step.

As described herein, methods or steps may be used to repair a mitral valve. However, it will be apparent after reading this disclosure that the techniques, steps and methods described herein may be useful for other surgical treatments as well.

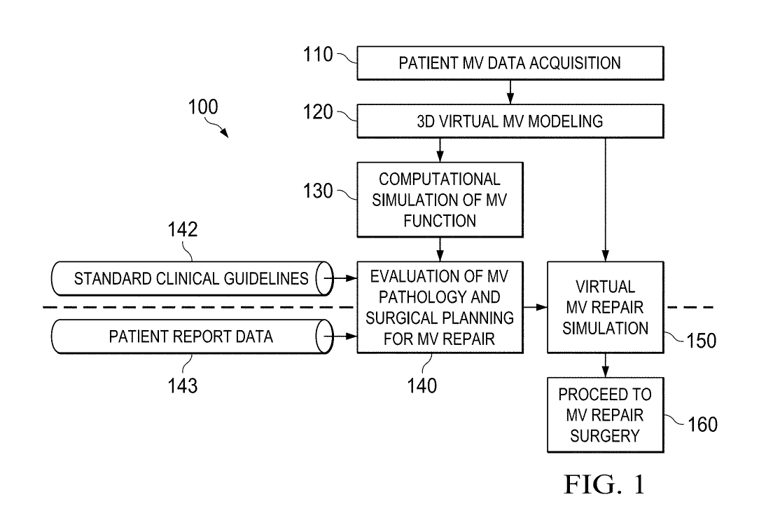

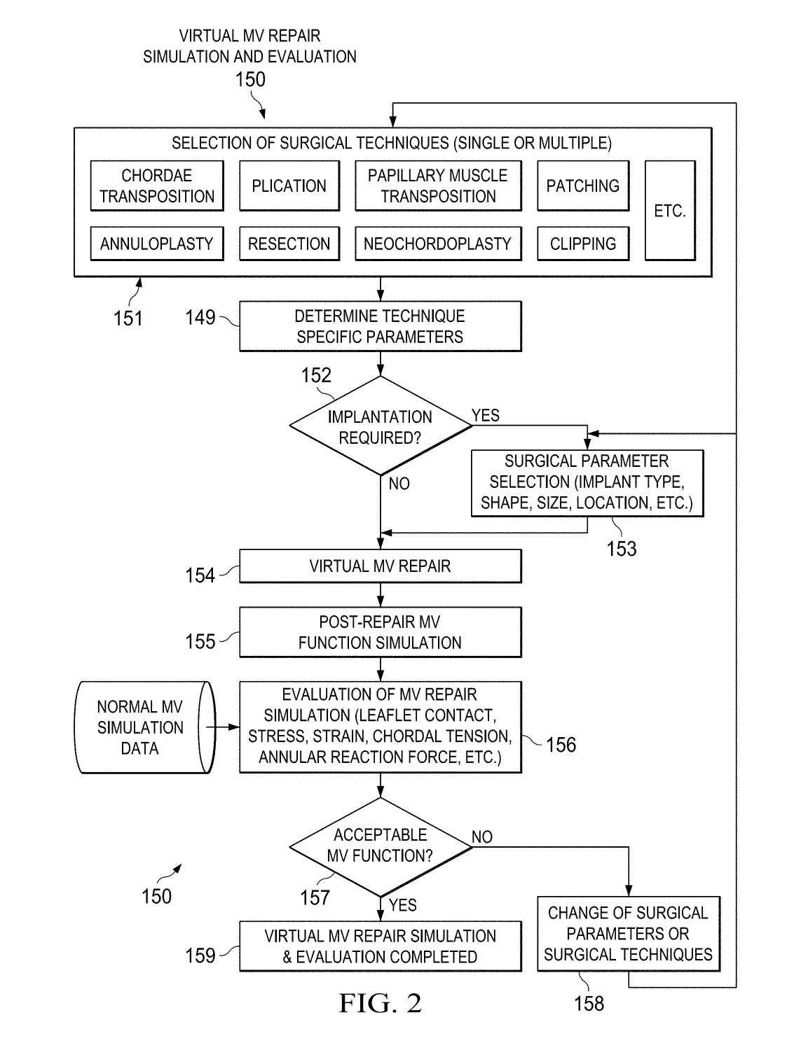

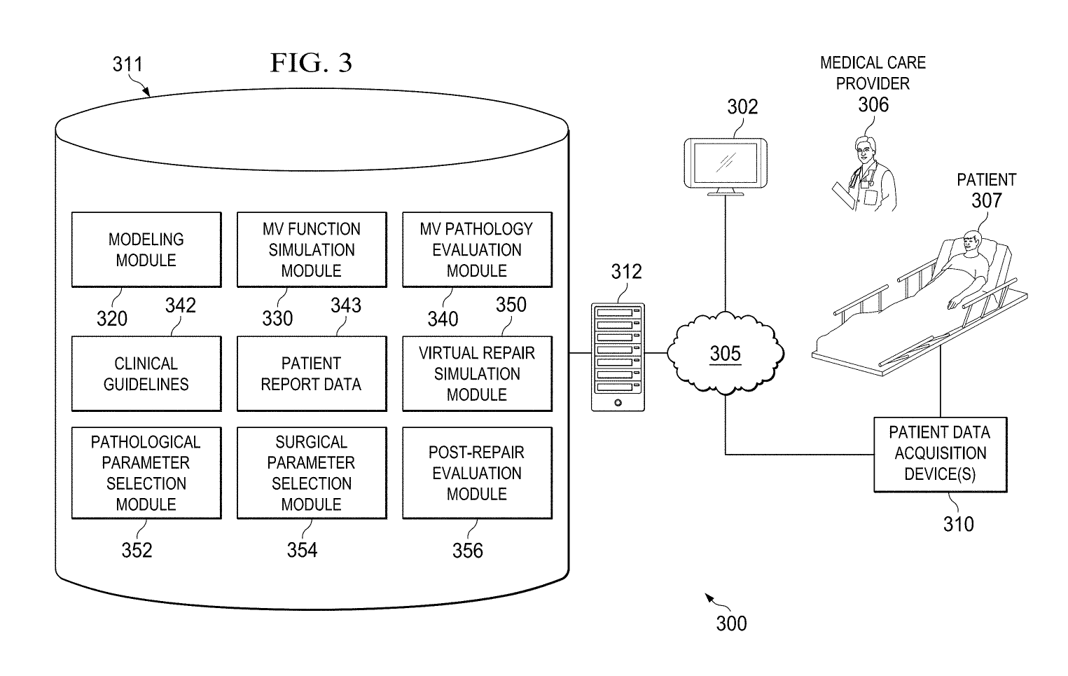

Referring to FIGS. 1-3, embodiments of a virtual MV repair simulation method and system are described. FIG. 1 depicts a flow chart illustrating steps that may be used to implement embodiments of methods for identifying, selecting, simulating, or analyzing surgical treatments. FIG. 2 depicts a flow diagram illustrating one method for virtual MV repair, simulation, and evaluation. FIG. 3 depicts one embodiment of a system for implementing methods for virtual MV repair and evaluation.

The system depicted in FIG. 3 will be described in the context of the processes shown in FIGS. 1 and 2. FIG. 3 shows a system 300 including a computer 302 connected to a network 305. The computer 302 includes visual display. The visual display may be comprised of a computer monitor at a workstation, a remote monitor, etc. The visual display may also be comprised of a heads-up display projected on a face shield used to protect surgeons from blood splatter/spray or a wearable computer with an optical head-mounted display. The visual display can facilitate instructional capabilities, as well as allow potential “real time” adjustments to a procedure while in progress. The computer 302 may be used by a medical care provider 306 to communicate with a server 312 to access data stored in a data repository 311. Patient data acquisition device(s) 310 are also connected to the network 305 for acquiring data from a patient 307.

Referring again to the flow chart depicted in FIG. 1, a process 100 is shown for identifying, selecting, simulating, or analyzing surgical treatments. At step 110, patient MV data is acquired. In one example, the patent data acquired includes image and/or Doppler (e.g., ultrasound) data. Patient data may be acquired by downloading information from the patient data acquisition device(s) 310, or any other desired method. For example, patient data acquired may include three-dimensional volumetric image acquisition, cut-plane image generation in a cylindrical coordinate system, or some other protocol for acquiring the necessary patient data. In some embodiments, patient image data comprises MV image data. MV data acquired may include geometric information relating to the valve structure. Flow information is also collected, which shows how blood flows through the valve over time as the valve opens and closes.

Various techniques known to those skilled in the art may be used to collect patient data. For example, a doctor may use standard echo protocol to collect patient MV image data. In some embodiments, a doctor may use previously collected clinical data. In some embodiments, three-dimensional (3D) imaging may be used. 3D echocardiography can provide detailed morphology of the MV leaflets and annulus contributing to an understanding of MV function and anatomy. 3D assessment may be more suitable for the evaluation of MV function because of the complex MV structure, including the asymmetric leaflets, chordae tendineae, papillary muscles, and mitral annulus. 3D transesophageal echocardiography (TEE) may be used by surgeons to evaluate MV geometry and focus the surgical procedure, particularly for MV prolapse.

Current clinical 3D echocardiography can demonstrate excellent volumetric morphology of the MV apparatus and provide information on the regurgitant flow jet across the MV leaflets using Doppler ultrasound in real time, allowing evaluation of mitral regurgitation. Quantitative biomechanical information, such as high stress concentration, leaflet contact, and abnormal bending curvature of the MV is not available from 3D echocardiography alone. However, biomechanical information is necessary to accurately understand MV pathophysiology and predict potential functional alterations. Precise 3D geometry of the MV apparatus acquired from 3D echocardiography can be utilized for computational evaluation of MV functional characteristics.

At step 120, the acquired patient data is used to create a virtual model. In some embodiments, data acquired from patient data acquisition device 310 may be imported into modeling module 320 (FIG. 3). Virtual modeling may occur in real time, or may be based on patient data previously stored, such as in data repository 311. There are various techniques for modeling the mitral valve. For example, physiological imaging modalities may be used to virtually model valves in the heart. In the case of mitral valve modeling, modeling may include—but is not limited to—segmentation of the MV annulus, leaflets and papillary muscles; image registration in the polar and Cartesian coordinate systems; surface modeling and meshing of the anterior and posterior leaflets; and modeling of the papillary muscles and chordae tendineae. Additional details and examples of 3D virtual MV modeling are provided below.

Once a virtual model has been generated for the mitral valve, the model may be used for the computational simulation of the mitral valve function for the patient, and may further be used for a surgical simulation. At step 130, a virtual model may be used to simulate a function of the MV. In some embodiments, virtual model information generated in modeling module 320 may be communicated to simulation module 330 (FIG. 3). Simulation of a patient's MV function may be useful for visualizing the problem to understand the problem as it relates to the patient. Embodiments may simulate the function of the entire heart, just the MV, or some portion of the heart that includes the MV. For example, embodiments may simulate just the function of the left ventricle and the MV. Simulation may include simulating the opening and closing of the valve or include the valve and fluid passing through the valve. Advantageously, 3D echocardiography, combined with computational simulations, can provide a powerful tool to evaluate complex structural and functional information of the MV apparatus. This computational methodology can help in understanding the dynamics of MV function and provide a comprehensive noninvasive imaging and evaluation method potentially improving the diagnosis and treatment of MV pathology.

Finite Element (FE) Analysis is one type of analysis useful for simulating the MV function for a patient. FE Analysis is an effective method for morphologic evaluation and stress determination of native aortic and mitral valves as well as bioprosthetic valves. This is due in part to an understanding that localized concentration of mechanical stress and large flexural deformations are closely related to tissue degeneration and calcification in heart valves. For example, studies have suggested that structural degeneration is frequently accompanied by excessive calcification on heart valve leaflets causing stenosis and cuspal tears. As another example relating to MV pathology, annular shape and geometric distribution of chordae tendineae play an important role with respect to functional valvular abnormalities. Understanding of valve function may improve if a comprehensive dynamic computational analysis of the MV complex is performed and the role played by individual structures (such as the annulus on regions of extreme stress concentration during valve function) can be determined.

In some embodiments, an evaluation may be performed to identify one or more mechanisms of pathophysiological involvement, such as annular enlargement, chordal lengthening, chordal rupture, calcification or proper leaflet coaptation. In some embodiments, an analysis of a patient's mitral valve may include comparing a simulation of a patient's mitral valve with a simulation of a mitral valve from another patient, from a previous simulation of the patient's own mitral valve, or some other simulation.

Once a simulation of the MV (pre-repair) has been performed, the MV pathology can be evaluated to determine one or more possible treatments. At step 140, the function of the mitral valve is evaluated. Evaluation of the MV may include importing computation simulation information into evaluation module 340 (FIG. 3). Any evaluation of the MV pathology and surgical planning for MV repair for a patient may implement standard clinical guidelines 142 and include patient report data 143. The data can be evaluated using any number of algorithms to determine if any medical actions should be recommended or data interpreted in a particular manner. Note that the patient report data 143 may also be used in step 130 (computational simulation of the MV function). Step 140 may also include determining a pathological parameter. For example, a pathological and etiologic parameter may be determined to be an anomalous shape, size, tissue, etc. In some embodiments, pathological parameter selection module 352 may identify an appropriate pathological parameter and/or determine the success of a surgical repair (FIG. 3).

At step 150, once a possible course of action has been identified, a treatment may be simulated. Simulation of a repair on a MV may be performed by virtual repair simulation module 350 using information received from MV function simulation module 340 (FIG. 3).

FIG. 2 depicts a flow diagram of one method for simulating a virtual MV repair (step 150 of FIG. 1). Simulation a virtual MV repair may involve simulation module 350 interacting with a virtual modeling module 320 to get information about a particular patient's heart (FIG. 3).

Additionally, FIG. 2 depicts a process 150 of virtual MV repair simulation and evaluation. In this example, one or more surgical treatments may be selected for simulation. At step 151, embodiments may select a surgical treatment involving an annuloplasty, a resection, mitral clipping, neochordoplasty, plication, patching, chordae transposition, papillary muscle transposition, or some other technique to simulate. Various surgical treatments may be simulated using embodiments of a virtual MV repair simulation system. The process shown in FIG. 2 can be interactive, in that a user (for example, a surgeon) can interact with the system to achieve desired results.

Depending on what technique is selected, parameters may need to be determined that are specific to the selected technique. At step 149, technique-specific parameters are determined. Next, at step 152, a determination may be made (for example, by a surgeon) whether implantation is required. An implantation may include the selection of a particular annuloplasty ring, artificial chordae, patch, clip, etc. If it is determined that an implant should be used, at step 153, a surgical parameter may be selected. A surgical selection may include an implant type, shape, size, location, or the like. In some embodiments, surgical selection module 354 may select an appropriate implant (FIG. 3).

At step 154, after an implant is selected (if needed), a virtual MV repair is simulated. At step 155, post-repair MV function is simulated to determine the effectiveness of the selected surgical technique. The outcomes of the simulated post-repair MV function can be presented on the display device. Next, at step 156, a simulation of the post-repair MV function simulation may be evaluated. In some embodiments, post-repair evaluation module 356 may evaluate a simulation of the MV, including a repair. In some embodiments, an evaluation of the post-repair MV function may be evaluated against normal MV simulation data or against a pre-repair MV function for the patient, including a post-operative analysis of the success of a given repair procedure. An evaluation may include leaflet contact, stress, strain, chordal tension, annular reaction force, or the like.

After the evaluation, at step 157, a determination is made as to whether the function of the simulated post-repair MV is acceptable. Determining whether the post-repair MV function is acceptable may include determining whether a pathologic parameter is within an acceptable range or whether an evaluated post-repair parameter is within an acceptable range. For example, an acceptable post-repair parameter may be that leaflet coaptation is fully restored and/or the chordal tension is less than the pre-repair chordal tension. Other examples are also possible. Also, if desired, a user may continue to try surgical treatments even when an acceptable treatment has already been identified.

If, at step 157, it was determined that the post-repair MV function was unsuccessful, or if there are more treatments to be evaluated, the process proceeds to step 158, where one or more surgical parameters or surgical techniques may be changed and the steps repeated until an acceptable repair is identified. If the post-repair MV function is determined to be acceptable, or presents a more favorable projected outcome, the virtual repair simulation and evaluation may be completed at step 159, and at step 160 (FIG. 1), the identified MV repair treatment may proceed.

If desired, a post-surgical analysis can be performed to see how well the procedure went. The post-surgical analysis can be done on the same patient that was the subject of the pre-surgical analysis (steps 110 through 150) and the identified procedure. Alternatively, the post-surgical analysis can be done on a patient that had a “normal” procedure, one not involving the selected procedure, and used to analyze the procedure's effect and success. The post-surgical analysis can provide an objective measurement of the outcome of a surgical procedure. In one example, a post-surgical analysis is conducted in the same manner as the pre-surgical analysis (e.g., steps 110 through 130, described above).

In some embodiments, the 3D virtual MV modeling protocol described above (step 120 in FIG. 1) is comprised of multiple sub-algorithms, including patient 3D TEE image data processing, MV leaflets and apparatus segmentation, image registration, 3D reconstruction, mesh creation, chordae tendineae creation, and incorporation of 3D dynamic motion of the annulus and papillary muscles. The ECG-gated patient 3D TEE data containing the full volumetric geometry of the anterior and posterior leaflets and annulus is transferred from an ultrasound system to a personal computer. In one example, MV apparatus, including the leaflets and annulus at end diastole (open), is identified, segmented and traced in eighteen evenly positioned cut-plane images in the cylindrical coordinate system using a custom-designed semi-automated image processing algorithm. In addition to segmentation and tracing of the MV leaflets and annulus at end diastole, the annular geometry at peak systole (closed) is segmented and traced in the same manner. These traced 3D geometric data are then transformed into Cartesian coordinates. Applying the non-uniform rational B-spline (NURBS) surface modeling technique to the traced 3D geometric data, the 3D MV leaflets and annulus are created and subsequently meshed. The papillary muscle tips are identified and modeled continuously deforming during dynamic annular motion. A total of 21 chordae tendineae including two strut chordae are modeled connecting the papillary muscles and the anterior and posterior leaflet. The marginal chordae tendineae are modeled by adding line elements between the papillary muscle tips and the marginal free edge nodes of both leaflets. The chordae insertion is distributed around the papillary muscles. Following incorporation of 3D dynamic motion of the annulus and PM tips, the 3D virtual MV modeling is completed.

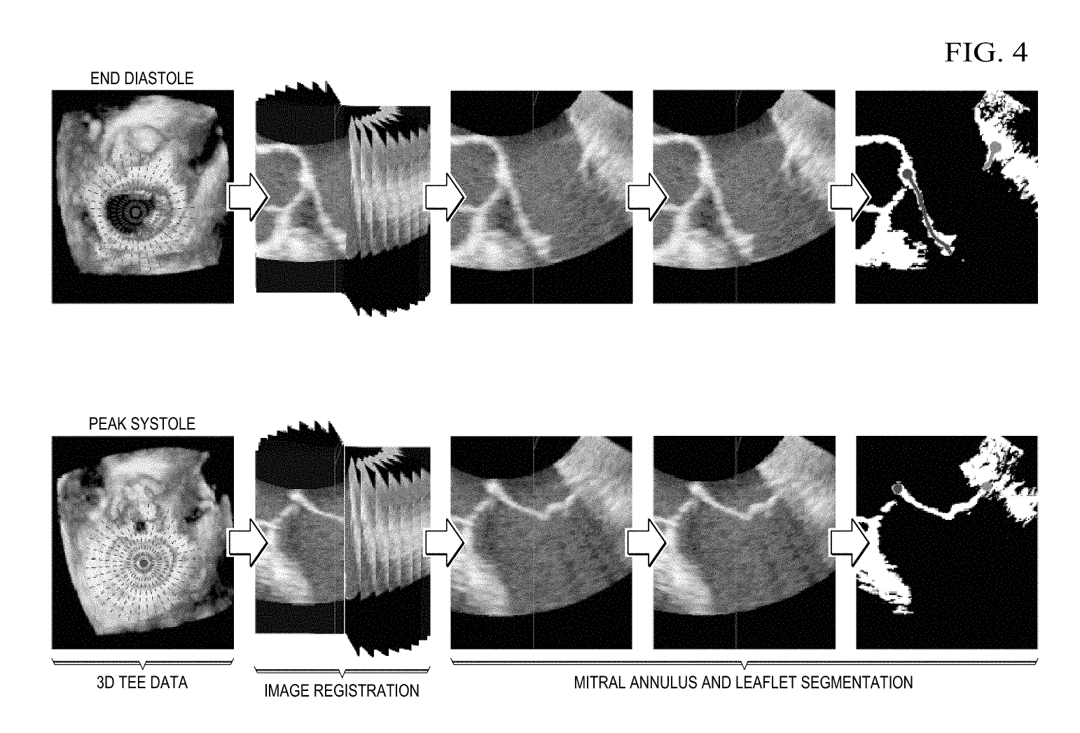

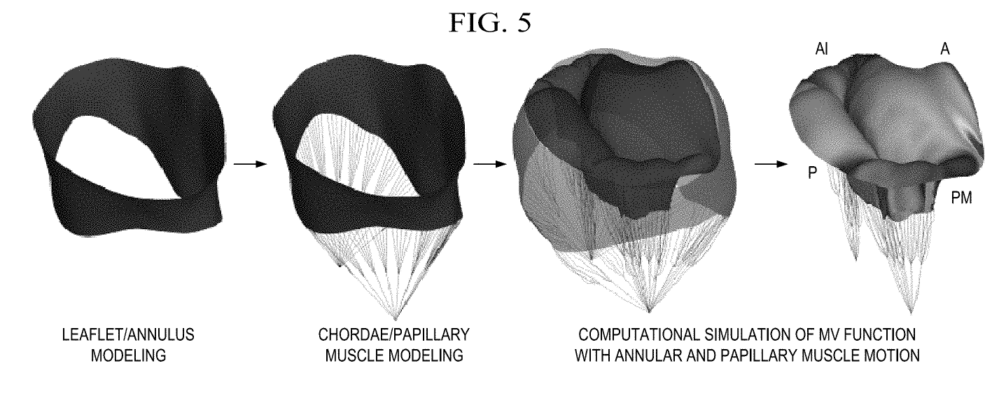

FIGS. 4-5 show a series of protocol schematics of the computational MV modeling using patient 3D TEE data followed by dynamic FE analysis to evaluate MV function. FIG. 4 shows 3D TEE data acquisition and MV apparatus segmentation. FIG. 4 shows diagrams of the MV at end diastole (top row) and the MV at peak systole (bottom row). From left to right, FIG. 4 shows 3D TEE data acquisition, image registration, and mitral annulus and leaflet segmentation. FIG. 5 illustrates virtual MV modeling and computational simulation of MV function. From left to right, FIG. 5 shows leaflet/annulus modeling, chordae/papillary muscle modeling, and computational simulation of MV function with annular and papillary muscle motion.

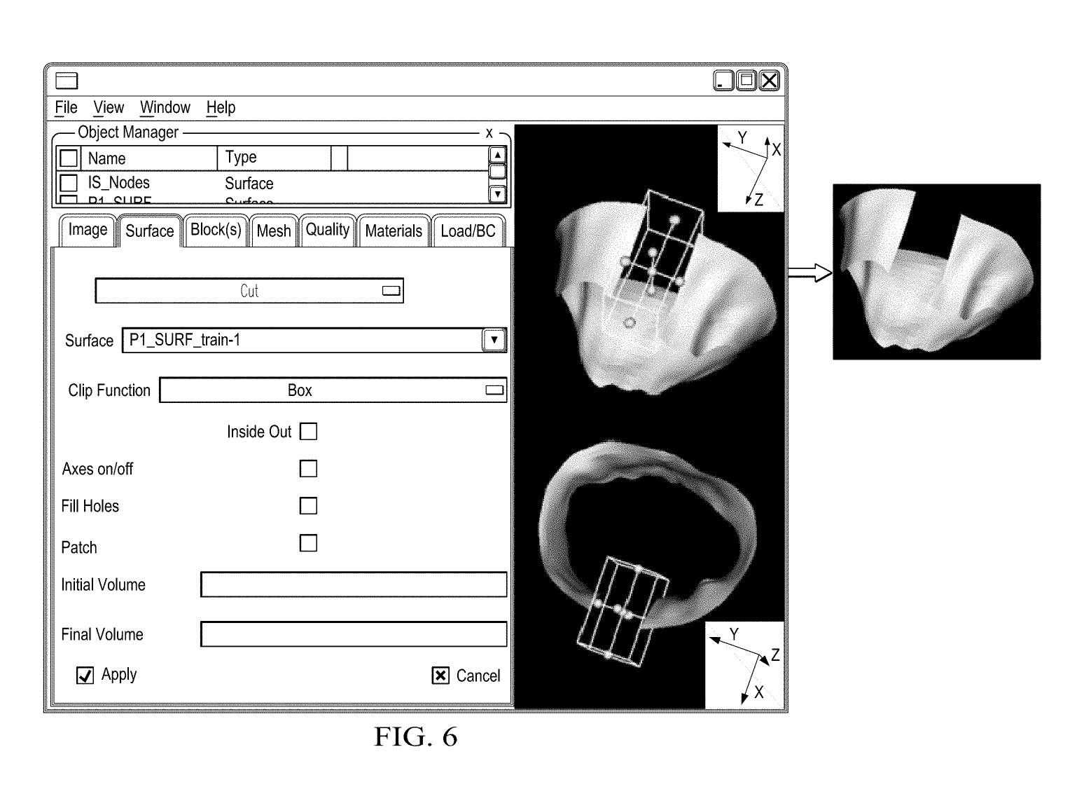

Referring again to computational simulation of MV repair (step 150 of FIG. 1, 154 of FIG. 2), FIG. 6 is a sample screenshot showing the computational simulation of MV repair in action. In this example, IA-FEMesh (a software toolkit) is used to facilitate modeling of anatomic MV model and perform a resection simulation.

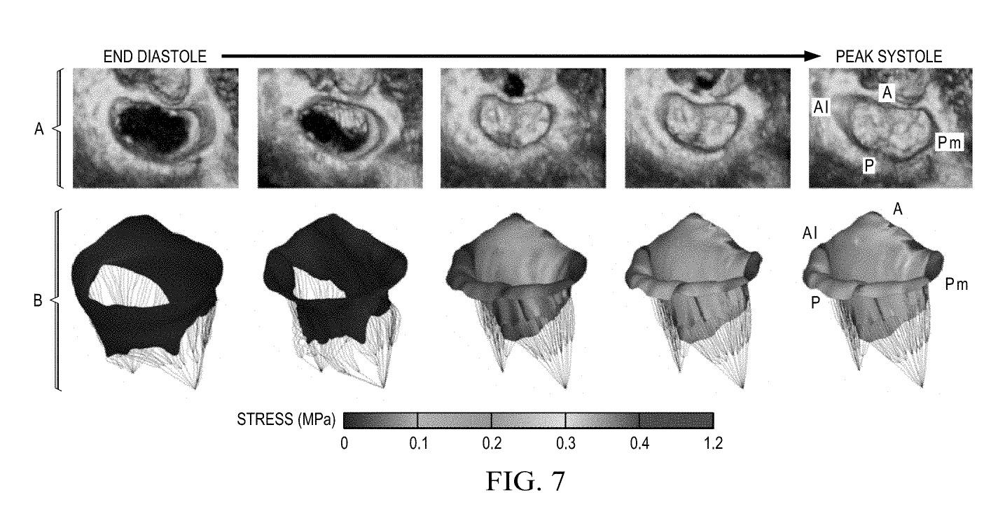

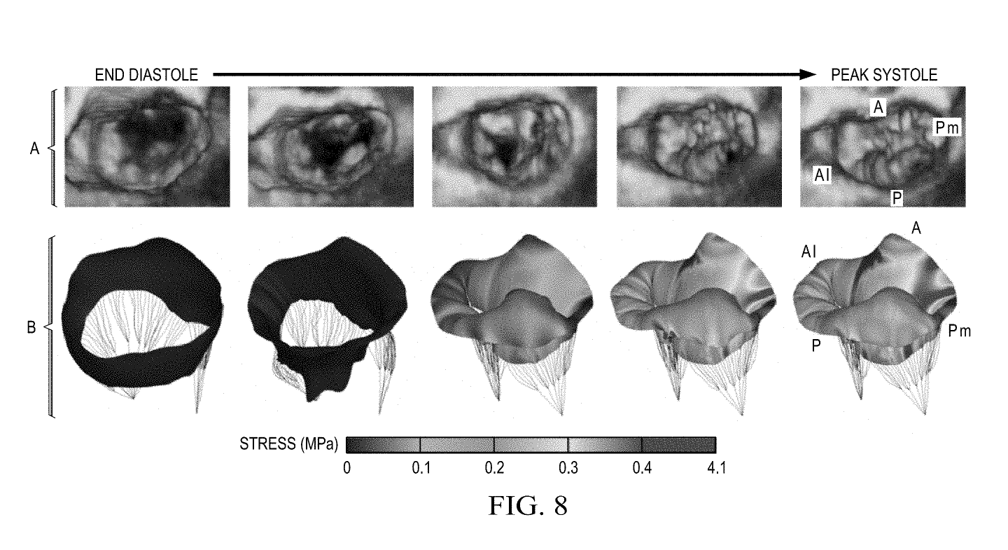

Following are exemplary descriptions of case studies of computational simulation of MV function across the cardiac cycle. FIG. 7 relates to a normal MV. FIG. 8 relates to an abnormal MV. The top row of images of FIG. 7 shows a patient 3D TEE data demonstrating volumetric images of a normal MV with normal leaflet coaptation (atrial view). The bottom row of images of FIG. 7 shows virtual MV models and MV simulation outcomes demonstrating dynamic motion of the annular morphology and stress distribution over the leaflets. As shown, computational MV evaluation corresponds well to the 3D TEE data and provides additional biomechanical and physiologic information of the MV. In FIGS. 7 and 8, the meaning of orientation designations is as follows: A=anterior; P=posterior; Al=anterolateral; and Pm=posteromedial.

The top row of images of FIG. 8 shows a patient 3D TEE data demonstrating volumetric images of a pathologic MV with posterior leaflet prolapse (atrial view). In this example, the P2 and P3 scallops in the flail leaflet were involved with chordal rupture. The bottom row of images of FIG. 7 shows virtual MV model and MV simulation outcomes demonstrating lail posterior leaflet prolapse and excessive leaflet stress concentration. As shown, computational MV evaluation corresponds well to the 3D TEE data and provides additional biomechanical and physiologic information of the MV.

Following is an exemplary surgical technique-specific selection/options that may be presented to a user subsequent to the user selecting a particular surgical technique. One typical example is ringless MV repair vs. ring annuloplasty. A surgeon could choose neochordoplasty without implanting an annuloplasty ring. If a post-repair simulation reveals insufficient leaflet coaptation or extremely large stress concentration, it may be the first choice to perform ring annuloplasty.

Another example is neochordoplasty vs. leaflet resection for ruptured chordae cases. Some cardiothoracic surgeons may prefer neochordoplasty to resection as they would want to save as much intact tissue as possible for any potential reoperation. In contrast, some surgeons believe leaflet resection has demonstrated good outcomes over a much longer time, i.e., consider resection as a more validated technique. Therefore, a user can try neochordoplasty, evaluate the simulation outcome, and try to perform leaflet resection again if the neochordoplasty simulation outcome is not satisfactory, and vice versa.

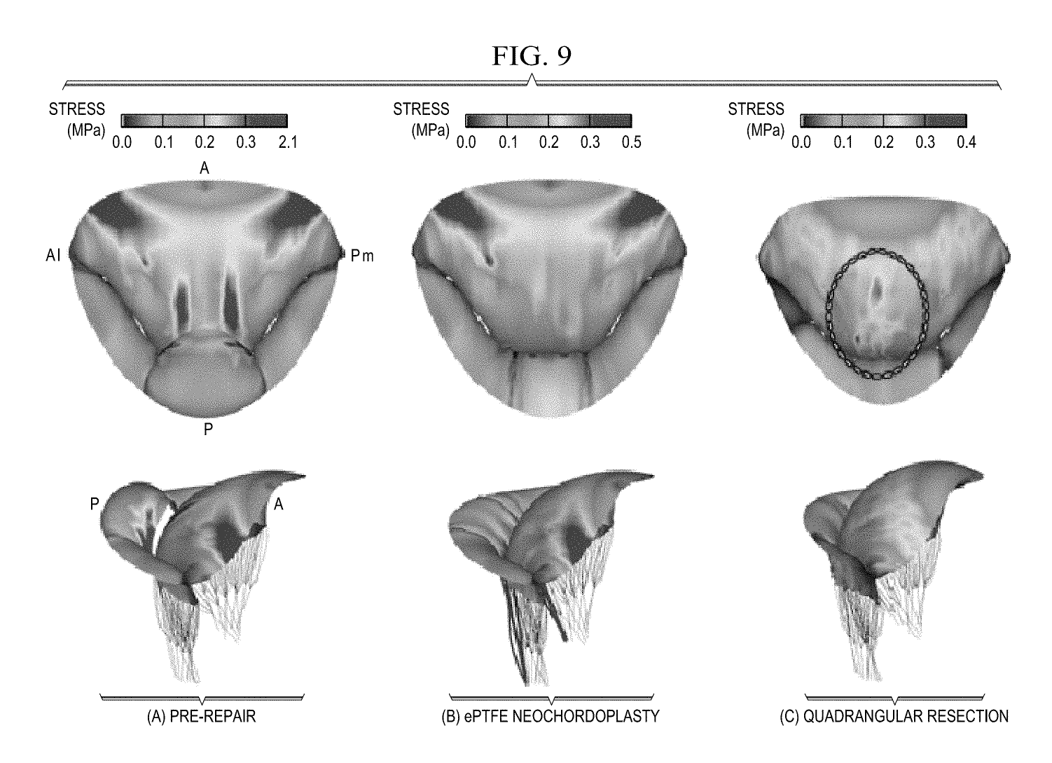

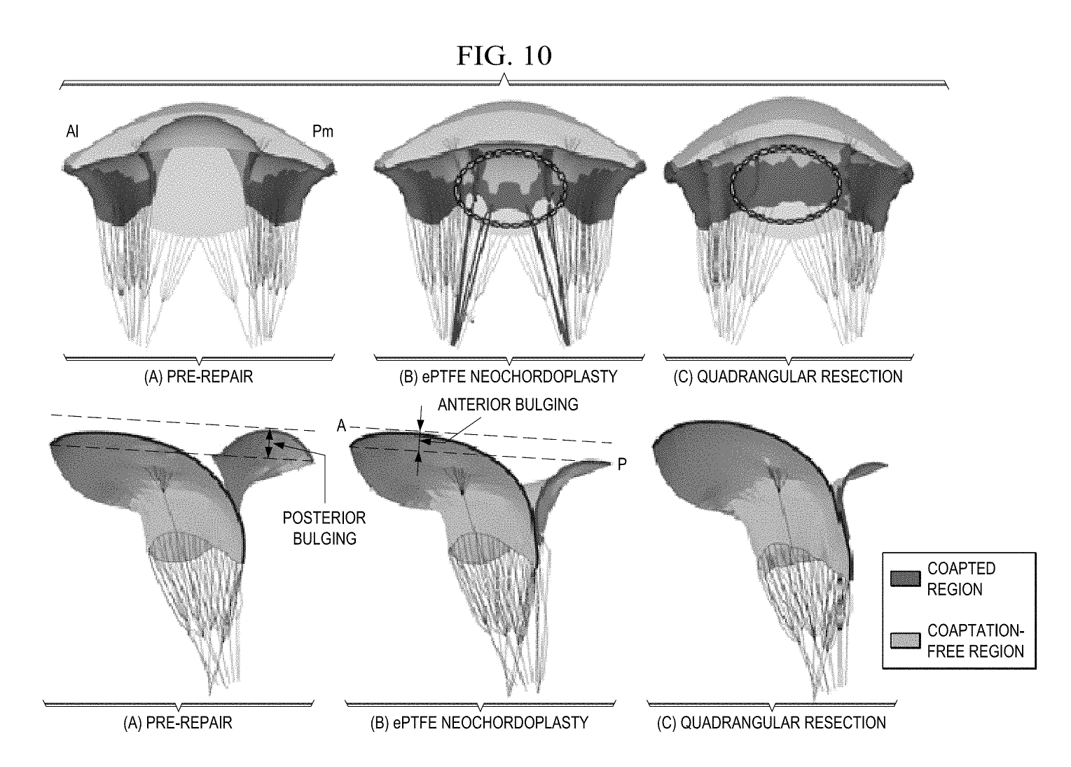

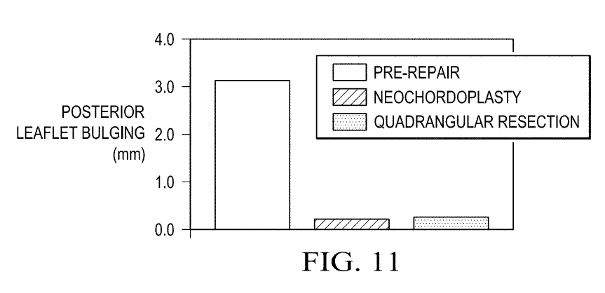

Following is an exemplary comparative study of computational simulation of a pathologic MV with P2 (i.e., the middle segment of the posterior leaflet) ruptured chordae accompanied by severe MR vs. post-MV repair using neochordoplasty vs. quadrangular resection. FIGS. 9-10 show various views of a pathologic MV, pre-repair and post repair. Views (A) show views of the pathologic MV, pre-repair. Views (B) show views of the pathologic MV repaired using a first treatment, for example, neochordoplasty. Views (C) show views of the pathologic MV repaired using a second treatment, for example, quadrangular resection. FIGS. 9-10 show reduced leaflet stress concentration and increased leaflet coaptation post-repair compared to pre-repair. FIG. 11 is a bar graph illustrating the posterior leaflet bulging (mm) for (1) pre-repair, (2) treated with neochordoplasty, and (3) treated with quadrangular resection. The simulated repairs and resulting data can help a user decide what treatment to use to treat the patient.

Some embodiments provide ways of producing a surgical guide from information from a virtual MV repair simulation to facilitate an actual surgical technique. Tissue marking dye (e.g., India ink) is commonly used in clinical and diagnostic procedures to mark skin for incision locations or mark tissue specimens during pathologic screenings. Some embodiments take advantage of tissue marking dyes/inks for the purposes of creating a transfer template that will be printed in “ink” in a fashion that can be easily transferred onto the mitral valve apparatus as a guide for the surgical procedure. In this way, after the user/surgeon performs virtual surgical repair and determines the desired repair approach, this repair can more easily be replicated on the patient if a template and guide are easily available. For example, suppose a surgeon determines, through the virtual surgical modeling, that the best approach is tissue resection. The surgeon then examines a few different tissue resection configurations to optimize the resection based on maximum stress, coaptation, etc. To implement this resection on the patient, rather than “eyeballing” the cut, a “PRINT” button is activated in the software, and a specialized printer prints a template based on the optimized configuration. This functions in a fashion similar to a temporary tattoo, where the ink easily transfers onto the tissue.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Example hardware architecture for implementing certain embodiments is generally described herein. One embodiment can include one or more computers communicatively coupled to a network. As is known to those skilled in the art, the computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (such as a mouse, trackball, stylus, etc.), or the like. In various embodiments, the computer has access to at least one database over the network. Embodiments discussed herein can be implemented in suitable computer-executable instructions that may reside on a computer readable medium (e.g., a HD), hardware circuitry or the like, or any combination.

ROM, RAM, and HD are tangible computer readable medium for storing computer-executable instructions executable by the CPU. Within this disclosure, the term “computer-readable medium” is not limited to ROM, RAM, and HD and can include any type of data storage medium that can be read by a processor. In some embodiments, a tangible computer-readable medium may refer to a data cartridge, a data backup magnetic tape, a floppy diskette, a flash memory drive, an optical data storage drive, a CD-ROM, ROM, RAM, HD, or the like.

At least portions of the functionalities or processes described herein can be implemented in suitable computer-executable instructions. The computer-executable instructions may be stored as software code components or modules on one or more computer readable media (such as non-volatile memories, volatile memories, DASD arrays, magnetic tapes, floppy diskettes, hard drives, optical storage devices, etc., or any other appropriate computer-readable medium or storage device). In one embodiment, the computer-executable instructions may include lines of compiled C++, Java, HTML, or any other programming or scripting code.

Additionally, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

As used herein, the terms “comprises,” “comprising,” “includes,” “including,” “has,” “having” or any other variation thereof, are intended to cover a non-exclusive inclusion. For example, a process, product, article, or apparatus that comprises a list of elements is not necessarily limited to only those elements but may include other elements not expressly listed or inherent to such process, product, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

The scope of the present disclosure should be determined by the following claims and their legal equivalents.

1-14. (canceled)

15. A system for simulating and evaluating mitral valve surgical techniques comprising:
at least one processor; and
at least one non-transitory computer readable medium storing instructions translatable by the at least one processor to perform:
acquiring mitral valve data from a mitral valve, wherein the mitral valve data is acquired from a patient using one or more data acquisition devices, and wherein the mitral valve data includes one or more images of the mitral valve and quantitative biomechanical data of the mitral valve;
using the acquired mitral valve data to create a virtual mitral valve representing the mitral valve using the mitral valve data from the data acquisition device, wherein the virtual mitral valve is a finite element model of the mitral valve;
simulating the function of the mitral valve based on the virtual finite element model of the mitral valve and the acquired mitral valve data;
simulating mitral valve repairs using a plurality of surgical technique simulations which repair the virtual mitral valve, wherein the valve repairs are simulated by corresponding modifications of the finite element model of the mitral valve;
simulating the function of the repaired mitral valve based on the modified finite element model of the mitral valve and the acquired mitral valve data;
comparing outcomes of the surgical technique simulations based on the simulations of the function of the repaired mitral valve;
presenting one or more of the outcomes of the surgical technique simulations to a user for selection of an optimal surgical technique for repairing the mitral valve.

16. The system of claim 15, wherein the plurality of surgical technique simulations includes one or more of annuloplasty, resection, neochordoplasty, mitral clipping, plication, patching, chordae transposition, papillary muscle transposition, and combinations thereof.

17. The system according to claim 15, wherein the simulated mitral valve repairs include the selection of an implant type, shape, size, and location.

18. The system according to claim 15, wherein the mitral valve data comprises mitral valve image data, mitral valve Doppler ultrasound data, mitral valve biomechanical data, or a combination thereof.

19. The system according to claim 18, further comprising determining blood flow characteristics based on Doppler ultrasound data.

20. The system according to claim 15, further comprising creating a virtual post-surgical mitral valve representing a post-surgical mitral valve.

21. The system according to claim 20, further comprising evaluating the effectiveness of a mitral valve surgical technique using the virtual post-surgical mitral valve.

22. The system of claim 15, further comprising performing the selected optimal surgical technique on the patient and thereby repairing the mitral valve.

23. The system of claim 15, wherein the at least one processor is further configured to perform, for at least one of the a plurality of surgical technique simulations, receiving user input defining one or more technique-specific parameters and performing the at least one of the plurality of surgical technique simulations according to the received technique-specific parameters.

24. The system of claim 15, wherein presenting the one or more outcomes of the surgical technique simulations to a user comprises generating a visual representation of each of the one or more outcomes of the surgical technique simulations and presenting to the user a graphical display of the visual representations of the one or more outcomes of the surgical technique simulations.
